(19) United States
(12) Patent Application Publication
(10) Pub. No.: US 2006/0210792 A1
(43) Pub. Date: Sep. 21, 2006

(54) ARTICLES WITH SELECTIVE ADHESIVE MECHANISM

(76) Inventors: David C. Windorski, Woodbury, MN (US); Kenneth J. Hanley, Eagan, MN (US); Ronald W. Most, Black Canyon City, AZ (US); Stephen L. Gamradt, Cottage Grove, MN (US)

Correspondence Address: 3M INNOVATIVE PROPERTIES COMPANY, PO BOX 33427, ST. PAUL, MN, 55133-3427, US

(21) Appl. No.: 11/276,202

(22) Filed: Feb. 17, 2006

Related U.S. Application Data
(63) Continuation-in-part of application No. PCT/US05/03594, filed on Feb. 4, 2005.
Application No. PCT/US05/03594 is a continuation-in-part of application No. 10/772,190, filed on Feb. 4, 2004.

(51) Int. Cl. B32B 7/12

(52) U.S. Cl. 428/343

(57) ABSTRACT

The invention provides an article having a plurality of sheets stacked on top of one another. Each sheet has opposing, first and second surfaces, opposing upper and lower 730 edges, and opposing first and second side edges. Disposed on the first surface and adjacent to the lower edge of the sheet is a securing mechanism that has an adhesive disposed between first and second raised elements. The first and second raised element each has an application surface. The pressure sensitive adhesive has an exposed surface. The height of the adhesive, as measured from its exposed surface to the second surface is shorter than the height of either raised element, as measured from its application surface to the second surface. The sheets are attached together using various means.

### CROSS-REFERENCE TO RELATED APPLICATIONS

This application is a continuation-in-part of International Application No. PCT/US2005/003594 filed on Feb. 4, 2005, which is a continuation-in-part of U.S. application Ser. No. 10/772,190 filed on Feb. 4, 2004. This application is also related to U.S. application Docket No. 61771US002, which is filed on even date herewith.

### FIELD OF THE INVENTION

The present invention relates to articles useful for displaying, organizing, and storing items that a user wishes to retain. The article uses a selective adhesion mechanism that allows the user to activate the adhesive on demand.

### BACKGROUND

There are various organizing tools available to a consumer that allowing her to keep a variety of similar materials and documents together. For example, many office workers use a Rolodex or a card file to organize and store business cards. Magnets, with or without mechanical attachment means such as clips, are useful items used by many to display materials, such as pictures, to do lists, tickets, coupons and the like on metal based surfaces, such as refrigerators and filing cabinets.

While commercially available devices such as those described above are useful to consumers, other articles that help display, organize, and or store various items are needed.

### SUMMARY

In one aspect, the present invention relates to an article comprising: (i) a plurality of sheets stacked on top of one another, each sheet having opposing, first and second surfaces, opposing upper and lower edges, and opposing first and second side edges; (ii) a securing mechanism disposed on the first surface and adjacent to the lower edge of each sheet, the mechanism comprising (a) first and second raised elements, each having an application surface and aligned generally parallel to and spaced apart from one another, and (b) a pressure sensitive adhesive having an exposed surface and disposed between the first and second raised element, wherein the height of the adhesive, as measured from its exposed surface to the second surface is shorter than the height of either raised element, as measured from its application surface to the second surface; and (iii) a means for attaching the plurality of sheets together.

In another aspect, the present invention relates to an article comprising a plurality of sheets in a stack, each sheet having opposing first and second surfaces, opposing upper and lower edges, and opposing first and second sides and a selective adhesion mechanism disposed on the first side of the sheet, the selective adhesion mechanism comprising: (i) first and second raised elements disposed adjacent to the lower edge of the sheet and generally parallel to and spaced apart form one another, each raised element having an application surface; (ii) a first repositionable pressure sensitive adhesive having an exposed surface and disposed between the first and second raised elements; (iii) a living hinge disposed between the securing mechanism and the upper edge of the sheet; (iv) means for attaching the plurality of sheets together. The height of the adhesive, as measured from the exposed surface of the adhesive to the second surface of the sheet is shorter than the height of either the first or the second raised element, as measured from the its application surface to the second surface of the sheet. The first and second raised element and the adhesive are continuous from the first side to the second side edge of the sheet. The term “living hinge” means a hinge that can be activated when desired by a user.

For the inventive articles, the first surface of each sheet is that side that is directly accessible to the user as she faces it. That is to say, as the article is placed on, e.g., a table top, the first surface of a first sheet is that which is in direct line of sight of the user, while the second surface is not in her direct line of sight until the user flips the first sheet over or otherwise removes the sheet from the pad thereby exposing the second surface of the first sheet and the first surface of a subsequent sheet. Furthermore, while the articles include a plurality of sheets that form a pad, the article can be used in pad form and it has the flexibility where each sheet in the pad may be removed and used individually, if desired.

The article of the present invention includes a pressure sensitive adhesive that is exposed on a portion of the first surface of the sheet. The adhesive is effectively recessed by means of one or more raised elements that extend from the sheet to a height greater than the height of the exposed face of the adhesive thereon.

When the sheet has its first surface abutting another surface, such as another sheet, it will not adhere thereto because the pressure sensitive adhesive thereon is spaced from that surface. When a threshold level of pressure is applied, the sheet bearing the adhesive is sufficiently flexible and deformable so that at least a portion of the exposed adhesive is brought into abutting engagement with the surface to adhere thereto without collapsing the raised element. When the threshold pressure is applied, the raised element may deform in response to the pressure, but they will not collapse, meaning that they will not flatten out so as to disappear. In a typical situation, the threshold level of pressure would most likely be applied as the user places an item, such as a business card, a coupon, or the like onto the securing mechanism. The pressure can be applied substantially normal to the pressure sensitive adhesive.

The threshold level of pressure would typically be manual, such as by pressing against the first surface of the sheet with fingers of the user's hand. This activation of the securing mechanism by the user provides adhesion “on demand”, i.e., adhesion at the time the user wants adhesive property. This external applied pressure (i.e., compressive force) would typically be exerted in a direction substantially normal to the first side of the sheet. This pressure creates an adhesion peel force of the adhesive to the surface after activation that is greater than the adhesion peel force (which is substantially zero) before activation by the user and which is sufficient to adhere the sheet to the surface.

The inventive article provides a mechanism for attaching other sheet materials, such as documents of various sizes, including, but not limited to, business cards, coupons, “to do” lists, and the like. In another application, the inventive article functions similar to a backbone of a book, which is formed when sheets of paper are attached thereto. Thus the inventive article can organize, bind, collect, display, store, and save such sheet materials until needed. The sheets in the inventive article do not need a liner to protect the securing mechanism or the sheet. If desired, however, a liner can be used.

In this document, the terms “upper” and “lower” edges and any other terms that relate to orientation are used to indicate relative positions. All numerical terms in this document are presumed to be modified by the term “about”.

### BRIEF DESCRIPTION OF THE DRAWINGS

The invention can be further described with reference to the following drawings, wherein:

FIG. 1 is a top plan view of one embodiment of the present invention;

FIGS. 2A and 2B are cross-sectional views of a plurality of sheets of FIG. 1 combined in a pad;

FIGS. 3A is cross sectional views of the embodiment of FIG. 1 taken along line 3-3;

FIG. 3B is a cross-sectional view of the embodiment of FIG. 3 where the inventive article has been used to attach a substrate, such as a business card;

FIG. 4 is a top plan view of another embodiment of the present invention;

FIG. 5 is a top plan view of another embodiment of the present invention;

FIG. 6 is a cross-sectional view of another embodiment of the present invention; and

FIG. 7 is a cross-sectional view of another embodiment of the present invention.

These figures are illustrative and are not drawn to scale. While the above drawing figures show several embodiments of the present invention, other embodiments are also contemplated, as noted in this disclosure. This disclosure presents the invention by way of representation and not limitation. Other modifications and embodiments can be devised by those skilled in the art that fall within the scope and spirit of the principles of the invention.

### DETAILED DESCRIPTION

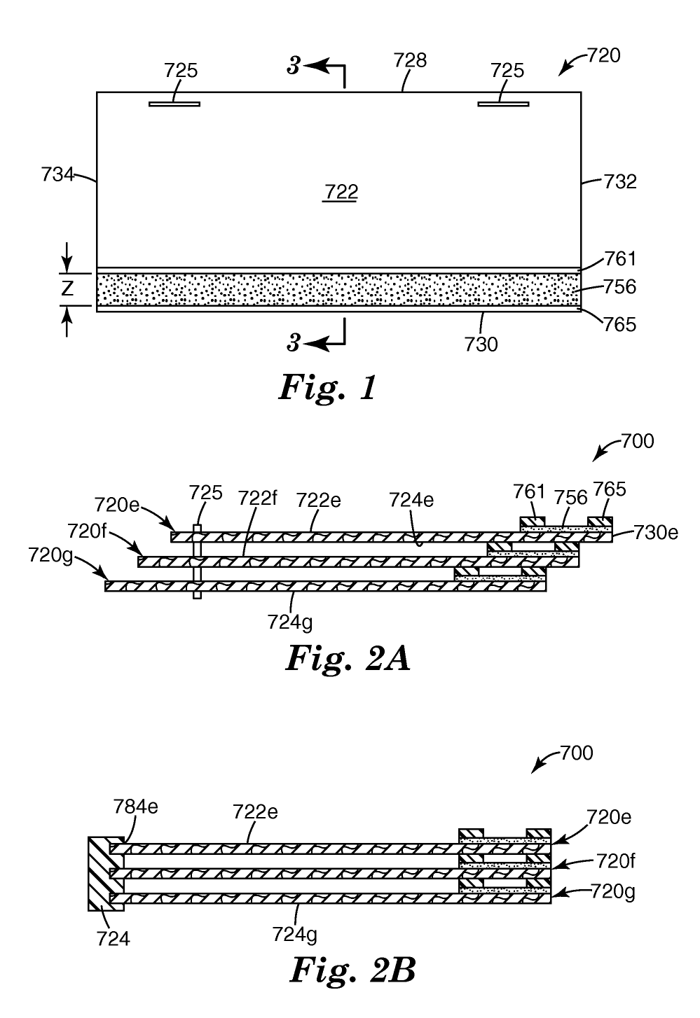

FIG. 1 shows a top plan view of sheet 720 having first surface 722 and a securing mechanism that would be in a user's line of sight as she faces the sheet. In this embodiment, the article has generally a rectangular shape, opposing upper 728 and lower 730 edges, and opposing first 732 and second 734 side edges. A securing mechanism is disposed adjacent the lower edge of the article. The term “adjacent” means generally in the vicinity near the lower edge and is not intended to mean that the securing mechanism has to be immediately next to the lower edge. The securing mechanism includes pressure sensitive adhesive 756 disposed between first raised element 761 and second raised element 765. The raised elements are generally linear, parallel to, and spaced apart from one another a distance Z. While this embodiment shows that the first and second raised elements and the adhesive are continuous spanning across the width of the article from the first to the second side edge, as described below in detail, they do not have to be continuous.

FIG. 2A shows a cross sectional view of a plurality of sheets 720e, 720f, and 720g attached to form article 700 of the present invention. As shown article 700 is in a pad form. The sheets are mechanically attached to one another via a mechanical means, such as staple 725. Only three sheets are shown for ease of discussion, and the sheets are, but need not be, staggered from one another. Sheet 720e, e.g., has on its first surface 722e a securing mechanism adjacent lower edge 730e. The securing mechanism includes first 761 and second 765 raised elements disposed on adhesive 756. The plurality of sheets is stacked such that first sheet 720eis disposed on subsequent sheet 720f such that second side 724e of first sheet 720e is proximate to first side 722f of subsequent sheet 720f. The securing mechanism associated with sheet 720f is proximate to and may contact second side 724e of first sheet 720e.

FIG. 2B is similar to FIG. 2A except that padding compound 724 is used to attach the plurality of sheets together at the upper edge. Use of the padding compounds creates living hinge 784e so that sheet 720e can be flipped or simply pivoted to expose subsequent sheet 720f, to facilitate the attachment of other items. In this embodiment, the sheets are not staggered.

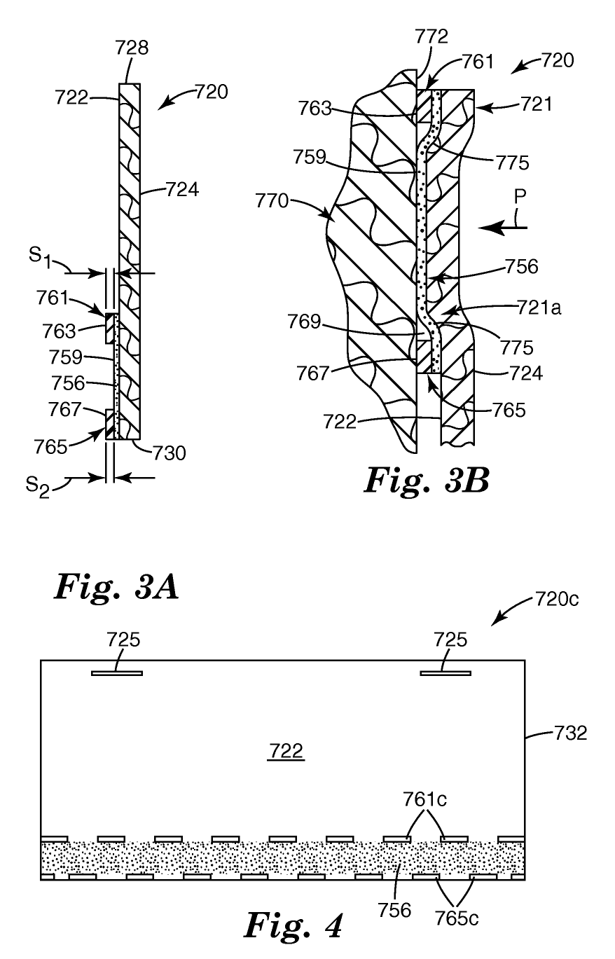

FIG. 3A is a cross-sectional view of the sheet of FIG. 1 taken along line 3-3. In this embodiment, first raised element 761 and second raised element 765 are adhered to exposed surface 759 of pressure sensitive adhesive 756. The first raised element has a first application surface 763 and the second raised element has second application surface 767. The distance from first application surface 763 or from second application surface 767 of each raised element to first side 722 of the sheet is greater than the distance from exposed surface 759 of the pressure sensitive adhesive to the first side 722 of the sheet. As shown, first and second raised elements project outwardly from the exposed surface of the adhesive a standoff distance S₁ and S₂ respectively. In one embodiment, S₁ is equal to S₂, although they do not have to be equal.

Standoff distances S₁ and S₂ are sufficient to space or separate exposed surface 759 of adhesive 756 from contacting an adjacent surface allowing the sheet to be handled and moved across the adjacent surface without adhering thereto by adhesive 756. Exemplary adjacent surfaces include, but are not limited to, another sheet, a desktop, or a wall. Thus, contact by the sheet with the adjacent surface is via the first and second raised elements and the portion of second surface 724 of the sheet that is free of adhesive. The first and second raised elements effectively provide borders for recess zone 769 therebetween where the exposed surface 759 of adhesive 756 is disposed.

As seen in FIG. 3B, substrate 770, such as, e.g., a business card, has mounting surface 772, such as a backside (e.g., a printed side) of the business card. The standoff distances S₁ and S₂ prevent the adherence of exposed surface 759 of adhesive 756 in recess zone 769 with mounting surface 772 in the absence of a threshold level of pressure applied against second surface 724 of the sheet opposite adhesive 756. When a threshold level of pressure is applied, however, sheet 720 is sufficiently flexible and deformable so that at least a portion of exposed surface 759 of adhesive 756 contacts mounting surface 772 and adheres thereto. The pressure applied would typically be manual, such as by pressing against second side 724 of sheet 720 with the fingers, palm, or hand of a user, in a direction generally denoted as P. Alternatively, the threshold pressure can be applied to substrate 770 in a direction opposite of P for on demand adhesion of the substrate to the sheet. While adhesive 756 is activated to retain the sheet to the substrate, the sheet may deform on its front side, although the deformation may not be visually or tactilely appreciable to the user. The first and second raised elements may, under pressure P, compress slightly, but still retain sufficient height to space the sheet from the mounting substrate. Thus, when the securing mechanism is activated to provide adhesion on demand, the raised elements are not collapsed. Although FIGS. 1, 2A, 2B, 3A and 3B show a first and second raised element, in some embodiments, three or more raised elements may be used, in which case, they will be spaced equidistance apart so that the recess zone is substantially equal.

FIG. 4 is a top plan view of the first surface of another embodiment of the present invention. Sheet 720c has on its first surface 722 first raised elements 761c and second raised elements 765c in the form of discontinuous strips or separated segments. In yet another embodiment, a combination of continuous and discontinuous strips can be used. The first and second raised elements can be aligned over adhesive 756 or proximate thereto, and although discontinuous, are aligned in a generally linear and parallel to one another. The separated segments of the first and second raised elements may be of the same length or of different length, so long as the raised elements serve the function of providing the standoff distance necessary to prevent unintended adhesion of the exposed surface 759 of adhesive 756 but still provide the “on demand” adhesive characteristic for sheet 720c.

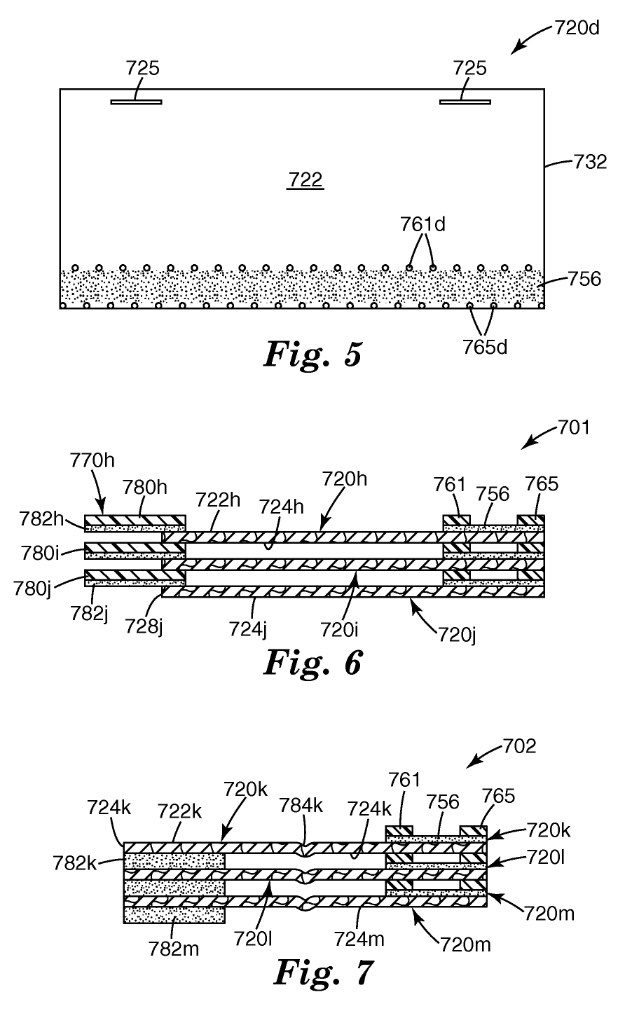

FIG. 5 is a top plan view of another embodiment of the present invention showing discontinuous strips of first and second raised elements, 761d and 765d respectively, in the form of a plurality of discrete drops or beads. The raised elements are aligned in a generally linear and parallel arrangement with the adhesive disposed in the recess zone which is between the raised elements. The discrete drops may be deposited in liquid form and then hardened or cured upon exposure to ambient conditions at a height that provides the requisite standoff distances for the first and second raised element relative to the exposed surface 759 of the adhesive. In this way, the “on-demand” characteristic provided by the securing mechanism is achieved.

FIG. 6 shows a cross-sectional view of another embodiment of the invention showing a plurality of sheets 720ₕ, 720i, and 720j forming pad 701. Similar to the previous embodiments, each sheet in this embodiment contains a securing mechanism that has adhesive 756 disposed between first 761 and second 765 raised elements. Disposed adjacent to upper edge of each sheet is an attachment for each sheet. For example, associated with sheet 720h is attachment 770h. The attachment provides a means for attaching the plurality of sheets together. It also provides a mechanism for displaying the pad or individual sheets in a surface. If desired, the attachment could be color coded to aid the user in organizing her materials. A living hinge is created at the junction of the attachment and the sheet. The attachment includes adhesive 782h disposed on a major surface of film 780h, a portion of the adhesive being in direct contact with first surface 722h of the sheet. In one embodiment, the adhesive for use with the attachment is a repositionable pressure sensitive adhesive. Article 701 is provided in a pad format where a portion of the adhesive of one attachment also contacts the film of the subsequent attachment. In use, one can attach a desired item to a first sheet of the pad. Another item can be attached to the pad by flipping the first sheet (e.g., sheet 720h) thereby exposing the subsequent sheet for attachment of additional items. The user can also detach the first sheet with its attached item (e.g., a business card) from the pad and display the combination on a vertical surface like a wall or refrigerator door.

FIG. 7 shows a cross-sectional view of another embodiment of the present invention showing a plurality of sheets 720k, 720l, and 720j forming article 702, which is in the form of a pad. First sheet 720k has opposing first 722k and second 724k surfaces. Like the previous embodiments, a securing mechanism is disposed on the first surface adjacent the lower edge of the sheet. Adhesive 782k, which in one embodiment is a repositionable pressure sensitive adhesive, is disposed near the upper edge of the sheet and on second surface 724k of sheet 720k. This embodiment further includes living hinge 784k disposed between the upper and lower edges. In one embodiment, the living hinge is a score line or a crease in the sheet.

The sheet should be of a material that deforms so as to allow the adhesive in the securing mechanism to overcome the recess defined for it and to contact the target substrate. The sheet should also be sufficiently flexible to allow for such contact and then resilient enough to resume its substantially original shape to allow the recess to be redefined once the sheet has been removed from the target substrate. Suitable examples of sheet materials include, but are not limited to, paper, plastic, canvas, fabric, and combinations thereof. The sheet size can be of any dimension. In one embodiment, the sheet is about 0.5 to 3 inches in width and about 3 to 11.5 inches in length. The sheet can have a thickness of 0.004 inch to 0.10 inch. In one embodiment, the portion of the first side of the sheet that comes into contact with the securing mechanism of the previous sheet will include an ink receptive coating allowing for writeability. In some embodiments, the sheet includes an ink receptive/writable coating coated on substantially the entire first and second surface. Suitable ink receptive coatings that exhibit release properties include those disclosed in U.S. Pat. Nos. 5,716,685 and 5,874,144.

Pressure sensitive adhesive (PSA) are known to those skilled in the art. In general, a PSA has properties such as, aggressive and permanent tack, adherence to a surface with no more than finger pressure, sufficient ability to hold onto an adherend, and sufficient cohesive strength.

In one embodiment, the pressure sensitive adhesive used in the securing mechanism is a repositionable pressure sensitive adhesive. Suitable repositionable adhesives are disclosed in U.S. Pat. Nos. 3,691,140 (Silver); 3,857,731 (Merrill et al.); 4,166,152 (Baker et al.); 4,495,318 (Howard); 5,045,569 (Delgado); 5,073,457 (Blackwell); 5,571,617 (Cooprider et al.); 5,663,241 (Takamatsu et al.); 5,714,237 (Cooprider et al.); U.S. RE 37,563 (Cooprider et al.); 5,756,625 (Crandall et al.) and 5,824,748 (Kesti et al.). The repositionable adhesive can be solvent based, water based, or can be a solventless, hot melt adhesive. The same repositionable pressure sensitive adhesive can be used for the attachment (shown in FIG. 6) or as the means for attaching the plurality of sheets together in the pad (as shown in FIG. 7).

The raised elements can be made from a variety material. Suitable examples include applying ultraviolet (UV) curable or water based coatings, which would eventually form the raised elements. For example, some curable coatings can self cure or are exposed to UV radiation for curing. Typically, water based coatings are dried in a conventional oven to evaporate the water. Another suitable material for the raised element is tape, where the adhesive side of the tape is disposed on the pressure sensitive adhesive or the first side of the sheet. It is desirable for the raised elements to leave substantially no residual mark on the target substrate to which the sheet is attached. Suitable standoff distance for the raised elements ranges from 0.0005 to 0.005 inch. The spacing between one raised element and subsequent raised element is between 0.25 to 2.0 inch.

The plurality of sheets is attached together to form the inventive articles. The sheets can be attached using any suitable means, including, but not limited to mechanical means, adhesive means, and binding means. Suitable mechanical means would include, but are not limited to, using a plurality of staples. Suitable adhesive means would include, but are not limited to, using a repositionable adhesive adjacent to the upper edge of the sheet. Suitable binding means would include, but are not limited to, a binding compound used to at the upper edge of the sheet forming the article.

One exemplary method for making the articles of the present invention includes providing a web of material, such as paper. Onto a first surface of the web, a PSA is coated, and dried, followed by coating the raised elements. If desired, an ink receptive coating is applied to at least a portion of the first and opposing second side of the web. The coated web can be converted to a plurality of individual sheets. The sheets can then be attached together to form the inventive article.

What is claimed is:

1. An article comprising:
a plurality of sheets stacked on top of one another, each sheet having opposing, first and second surfaces, opposing upper and lower edges, and opposing first and second side edges;
a securing mechanism disposed on the first surface and adjacent to the lower edge of each sheet, the mechanism comprising (a) first and second raised elements, each having an application surface and aligned generally parallel to and spaced apart from one another, and (b) a pressure sensitive adhesive having an exposed surface and disposed between the first and second raised element, wherein the height of the adhesive, as measured from its exposed surface to the second surface is shorter than the height of either raised element, as measured from its application surface to the second surface; and
a means for attaching the plurality of sheets together.

2. The article of claim 1, wherein in the absence of a threshold level of pressure applied to the securing mechanism, the pressure sensitive adhesive is spaced from a substrate and when a threshold level of pressure is applied to the securing mechanism, the adhesive comes into securing engagement with the substrate without collapsing the raised elements.

3. The article of claim 1, wherein the first and second raised element are disposed on a surface selected from the group consisting of the pressure sensitive adhesive, the first surface of the sheet, and a combination thereof.

4. The article of claim 1, wherein the pressure sensitive adhesive is a repositionable adhesive.

5. The article of claim 1, wherein at least one of the first and second raised element is selected from the group consisting of a continuous strip, a discontinuous strip, a bead, a plurality of beads, and combinations thereof.

6. The article of claim 1, wherein the sheet is selected from the group consisting of paper, plastic, canvas, fabric, and combinations thereof.

7. The article of claim 1, wherein the means for attaching the sheets together is selected from the group consisting of staples, padding compound, adhesives, and combinations thereof.

8. The article of claim 1, wherein the first surface of each sheet further comprises an ink receptive coating.

9. The article of claim 1, wherein the securing mechanism on each sheet is disposed generally in the same location from sheet to sheet.

10. The article of claim 1, wherein each sheet is staggered with respect to a subsequent sheet in the stack.

11. The article of claim 1, wherein the sheet further comprises a living hinge disposed between the securing mechanism and the means for attaching the sheet.

12. The article of claim 11, wherein the living hinge is selected from the group consisting of a crease and a performation in each sheet.

13. The article of claim 1, wherein the means for attaching the sheet is an attachment that comprises: (a) a polymeric film having opposing front and back surfaces; and (b) a repositionable adhesive disposed on the back surface of the film, the attachment disposed on the first side of each with a portion of the repositionable adhesive in contact with the first surface of the sheet.

14. An article comprising a plurality of sheets in a stack, each sheet having opposing first and second surfaces, opposing upper and lower edges, and opposing first and second sides and a selective adhesion mechanism disposed on the first side of the sheet, the selective adhesion mechanism comprising:
first and second raised elements disposed adjacent to the lower edge of the sheet and generally parallel to and spaced apart form one another, each raised element having an application surface;
a first repositionable pressure sensitive adhesive having an exposed surface and disposed between the first and second raised elements;
a living hinge disposed between the securing mechanism and the upper edge of the sheet;
means for attaching the plurality of sheets together;
wherein the height of the first repositionable pressure sensitive adhesive, as measured from the exposed surface of the adhesive to the second surface of the sheet is shorter than the height of either the first or the second raised element, as measured from the its application surface to the second surface of the sheet, and
wherein the first and second raised element and the adhesive are continuous from the first side to the second side edge of the sheet.

15. The article of claim 14, wherein in the absence of a threshold level of pressure applied to the adhesive, it is spaced from a substrate and in the presence of the threshold level of pressure, the adhesive comes into securing engagement with the substrate without collapsing the first and second raised elements.

16. The article of claim 14, wherein the means for attaching the plurality of sheets together comprises a second repositionable adhesive disposed on the second surface of each sheet.

17. The article of claim 14, wherein the first surface of each sheet further comprises an ink receptive coating.

18. The article of claim 14, wherein the sheet is selected from the group consisting of paper, plastic, canvas, fabric, and combinations thereof.

19. The article of claim 14, wherein the living is selected from the group consisting of a crease in the sheet and a perforation in the sheet.

20. The article of claim 14, wherein the adhesive is disposed generally in the same location from sheet to sheet.

21. The article of claim 14, wherein the means for attaching the plurality of sheets is an attachment that comprises (a) a polymeric film having opposing front and back surfaces; and (b) a second repositionable adhesive disposed on the back surface of the polymeric film, the attachment disposed on the first side of each sheet with a portion of the second repositionable adhesive in contact with the first side of the sheet.
